(19) United States
(12) Patent Application Publication
(10) Pub. No.: US 2016/0236980 A1
(43) Pub. Date: Aug. 18, 2016

(54) Bagged, Rubber-Modified, Hot Mix Asphalt Pre-Mix

(71) Applicant: M-B Companies, Inc., New Holstein, WI (US)

(72) Inventors: Steven A. Muellenbach, Kiel, WI (US); Adam L. O'Connor, Hughesville, PA (US)

(21) Appl. No.: 15/041,214

(22) Filed: Feb. 11, 2016

Related U.S. Application Data
(60) Provisional application No. 62/117,165, filed on Feb. 17, 2015.

(51) Int. Cl. C04B 16/04; E01C 23/10; B65B 63/08; E01C 7/24; E01C 7/26; C04B 26/26; E01C 23/14

(52) U.S. Cl. CPC C04B 16/04; C04B 26/26; E01C 23/10; E01C 23/14; E01C 7/24; E01C 7/265; B65B 63/08

(57) ABSTRACT

Packaged, rubber-modified, hot-mix asphalt pre-mix is prepared without first forming pellets of an asphalt binder and then coating the pellets with lime. In one embodiment the invention is a process of preparing a packaged, rubber-modified, hot-mix asphalt pre-mix in which a hot, rubber-modified asphalt binder is added directly to aggregate which is (1) of a temperature lower than that of the hot binder, and (2) held within a polyolefin package, e.g., a polyethylene bag.

### FIELD OF THE INVENTION

This invention relates to asphalt, asphalt pre-mixes, and asphalt and concrete pavement repair. In one aspect the invention relates to a packaged, rubber-modified hot asphalt pre-mix while in other aspects, the invention relates to a method of making the pre-mix, packaging the pre-mix, and using the packaged pre-mix to patch asphalt and concrete pavements. In yet another aspect, the invention relates to equipment used in the packaging of the pre-mix and using the pre-mix in the repair of asphalt and concrete pavements. In still other aspects, the invention relates to a packaged, rubber-modified, hot asphalt rejuvenator, and methods of making, packaging and using the packaged, rubber-modified, hot asphalt rejuvenator. In one particular aspect, the packaged, rubber-modified, hot asphalt rejuvenator is used to condition, i.e., rejuvenate, recycled asphalt product (RAP).

### BACKGROUND OF THE INVENTION

Asphalt (also known as bitumen), is, at ambient conditions (23° C. and atmospheric pressure), a sticky, black, highly viscous liquid or semi-solid form of petroleum refining residue. In one typical use, asphalt is combined with aggregate to form asphalt concrete (also, if not better, known as paving asphalt mixture, or hot mix asphalt (HMA)). In this use, asphalt is also known as “asphalt binder” or “asphalt cement binder”. Asphalt pavement wears over time due to a myriad of forces, e.g., traffic loads and volume, weathering (e.g., freeze/thaw cycles), etc., and this wear often results in cracks and holes (e.g., “potholes”) of significant size that require patching.

Rubber-modified, hot mix asphalt pre-mixes for asphalt and concrete pavement patching or other repair are known. Present manufacturing processes for such pre-mixes include a process of extruding and then pelletizing a modified asphalt binder, e.g., a binder comprising bitumen, crumb rubber, and optionally, one or more other ingredients such as a stripping agent, mineral fines, stiffening compounds, etc. The modified asphalt binder pellet is subsequently coated with a limestone or sulfur substance to prevent pellet agglomeration, mixed with aggregate, bagged, stored and eventually shipped to the site of the pavement repair.

At the site, the bags of modified asphalt binder pellets and aggregate are thrown or poured into a pug mill, heated and mixed to form a molten, uniform mixture of asphalt concrete, and then discharged from the pug mill directly into the hole or crack, or into a conveyance, e.g., a wheelbarrow, for conveyance to the hole or crack. The bags in which the modified asphalt binder pellets and aggregate were packaged, stored and transported may be discarded if constructed of paper or like material, or consumed in the pug mill if constructed of a plastic, e.g., a polyolefin such as polyethylene.

US 2010/0056669 to Bailey teaches a storage-stable rubberized asphalt paving pellet that can include fines in its core. The core can be an asphalt-based binder at about 70% to about 95% by weight of the core. The asphalt-based binder can include: ground tire rubber from about 15% to about 30% by weight of the asphalt-based binder, and pavement grade asphalt from about 85% to about 70% by weight of the asphalt based binder. The core can include fines at about 30% to about 1% by weight of the core. Coating the core can provide the pellet with a maximum dimension of about 1/16 inch to about 2 inches. This coating, or shell, can include a water-resistant polymer or wax, or lime fines or ground asphalt pavement fines, or mineral or rock fines.

U.S. Pat. No. 8,404,164 to Sockwell teaches a composition for pelletized bitumen and a method for preparing the same. The composition is comprised of: between 30% to 40% by weight of bitumen; between 15% to 30% by weight of stiffening compound; between 35% to 45% by weight of setting compound; and 0.05% by weight of water. The stiffening compound is comprised of between 10% to 20% by weight of ground asphalt shingles; between 5% to 10% by weight of vulcanized rubber; between 1% to 2% by weight of uintahite; and up to 0.5% by weight of zeolite. The stiffening compound may be Type II Portland cement.

While functional, such pellets and pelletized pre-mixes and the processes for making and packaging them are not without their drawbacks. For example, pelletizing the asphalt binder requires equipment to extrude, pelletize and coat the binder, and this all adds to the capital and operational costs of manufacturing the pre-mix. Eliminating the need for pelletizing the asphalt binder would clearly streamline the process of making the pre-mix, and this in turn, would lead to a simpler and more cost effective process. Moreover, if the bags used to package the pre-mix are incorporated into the patching material used to repair the pavement, this reduces waste and thus improves the overall efficiency of the pavement repair process.

### SUMMARY OF THE INVENTION

In one embodiment the invention is a process for preparing a packaged, rubber-modified, hot-mix asphalt pre-mix without forming pellets of an asphalt binder, either modified or unmodified. In one embodiment the invention is a process of preparing a packaged, rubber-modified, hot-mix asphalt pre-mix in which a hot, rubber-modified asphalt binder is added directly to aggregate which is (1) of a temperature lower than that of the hot binder, and (2) held within a polyolefin package, e.g., a polyethylene bag. In one embodiment the average U.S. Standard mesh size of the rubber particles in the rubber-modified asphalt binder is smaller than the average U.S. Standard mesh size of the aggregate particles so as to allow the rubber particles to fill the interstices between the aggregate particles during the filling of the polyolefin package (e.g., bag) with the hot, molten, rubber-modified asphalt binder, and/or during the compaction of the molten, rubber-modified, hot asphalt concrete in the asphalt or concrete pavement hole or crack under repair.

In one embodiment the invention is a packaged composition comprising:

(A) Rubber-modified asphalt binder;

(B) Non-bituminous adhesion promoter; and

(C) Aggregate;

the composition contained within a polyolefin package.

In one embodiment the invention is a process for making a packaged, rubber-modified, hot-mix asphalt pre-mix, the process comprising the steps of:
(1) Mixing rubber and asphalt binder at an elevated temperature to form a rubber-modified, liquid asphalt binder; and
(2) Adding the rubber-modified, liquid asphalt binder to a polyolefin package containing aggregate.
   In one embodiment, the rubber is a crumb rubber. In one embodiment a non-bituminous adhesion promoter is a component of the packaged, rubber-modified asphalt pre-mix. The non-bituminous adhesion promoter can be added at any time, e.g., it can first be blended with either the asphalt binder or rubber and then mixed with the other, or the asphalt binder and rubber can first be blended and then the non-bituminous adhesion promoter can be mixed with that blend, either method as part of blending step (1), or it can be added to the package separately at packaging step (2), a less preferred method.

In one embodiment the invention is a method of preparing a molten patching material for repair of asphalt and concrete pavements, the method comprising the steps of:
(1) Subjecting a rubber-modified, hot-mix asphalt pre-mix contained within a polyolefin package, the pre-mix comprising:
   (A) Rubber-modified asphalt binder; and
   (B) Aggregate;
   to sufficient mixing to open the package; and
(2) Subjecting the open package of rubber-modified asphalt pre-mix to sufficient mixing and heat to melt the package and form a substantially uniform blend of rubber-modified molten asphalt binder, aggregate and melted package.
   In one embodiment the rubber-modified, asphalt pre-mix comprises a non-bituminous adhesion promoter. In one embodiment a non-bituminous adhesion promoter is added to the rubber-modified asphalt pre-mix after the package is opened and the pre-mix and melted package are blended in step (2).

In one embodiment the invention is a method of patching asphalt or concrete pavements, the method comprising the steps of:
(1) Preparing a molten, rubber-modified, hot asphalt concrete from a rubber-modified, hot-mix asphalt pre-mix comprising an asphalt binder, aggregate and an adhesion promoter all contained within a polyolefin package; and
(2) Depositing the molten, rubber-modified, hot asphalt concrete onto or into an area of the asphalt or concrete pavement in need of repair.

In one embodiment the invention is a packaged composition comprising:
(A) Molded, rubber-modified asphalt binder; and
(B) Non-bituminous adhesion promoter;
   the composition contained within a polyolefin package.

In one embodiment the invention is a process for making a packaged, rubber-modified asphalt binder to rejuvenate and rubberize recycled asphalt product (RAP), the process comprising the steps of :
(1) Mixing rubber, asphalt binder and a non-bituminous adhesion promoter at an elevated temperature to form a rubber-modified, liquid asphalt binder;
(2) Molding the rubber-modified, asphalt binder; and
(3) Adding the molded, rubber-modified, liquid asphalt binder to a polyolefin package.
   In one embodiment, the rubber is a crumb rubber. In one embodiment the non-bituminous adhesion promoter is first blended with either the asphalt binder or rubber and then mixed with the other. In one embodiment the asphalt binder and rubber are first blended with one another and then the non-bituminous adhesion promoter is mixed with that blend.

In one embodiment the invention is a process of rejuvenating recycled asphalt product (RAP), the process comprising the steps of:
(1) Heating RAP,
(2) Adding to the RAP a packaged, molded composition comprising:
   (A) Asphalt binder;
   (B) Rubber;
   (C) A non-bituminous adhesion promoter; and
   (D) A polyolefin package;
   the composition contained within the polyolefin package; and
(3) Mixing the heated RAP and packaged, molded composition until both the package and molded composition are liquefied and form a substantially homogeneous blend with the RAP.

### BRIEF DESCRIPTION OF THE DRAWINGS

FIGS. 1A-1D are illustrations of various configurations of molded, rubber-modified, hot-mix asphalt pre-mixes.

FIG. 2A is an illustration of one embodiment of a pug mill.

FIG. 2B is an illustration of one embodiment the interior of the pug mill of FIG. 2A showing the mounting and placement of the paddles and scrapers.

### DETAILED DESCRIPTION OF THE PREFERRED EMBODIMENT

### Definitions

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, product and processing designs, polymers, catalysts, definitions (to the extent not inconsistent with any definitions specifically provided in this disclosure), and general knowledge in the art.

The numerical ranges disclosed herein include all values from, and including, the lower value and the upper value. For ranges containing explicit values (e.g., 1 or 2, or 3 to 5, or 6, or 7) any subrange between any two explicit values is included (e.g., 1 to 2; 2 to 6; 5 to 7; 3 to 7; 5 to 6; etc.).

“Comprising,” “including,” “having” and like terms are not intended to exclude the presence of any additional component, step or procedure, whether or not the same is specifically disclosed. In order to avoid any doubt, all processes claimed through use of the term “comprising” may include one or more additional steps, pieces of equipment or component parts, and/or materials unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or,” unless stated otherwise, refers to the listed members individually as well as in any combination.

“Composition” and like terms mean a mixture or blend of two or more components.

“Olefin” and like terms mean an unsaturated, aliphatic or alicyclic, substituted or unsubstituted hydrocarbon having one or more double bonds. “Substituted olefin” means an olefin in which one or more hydrogen atoms bound to any carbon of the olefin is replaced by another group such as a halogen, aryl, substituted aryl, cycloalkyl, substituted cycloalkyl, hetero-cycloalkyl, substituted hetero-cycloalkyl, halogen, haloalkyl, hydroxy, phosphido, alkoxy, amino, thio, nitro, or a combinations of two or more such substituents.

“Polyolefin”, “olefin polymer,” “olefinic polymer,” “olefinic interpolymer,” and like terms mean a polymer derived' from simple olefins. Representative polyolefins include polyethylene, polypropylene, polybutene, polyisoprene and their various interpolymers.

“Concrete” and like terms mean any composite material composed of mineral aggregate adhered with a binder. “Asphalt concrete” is a compositional material commonly used to surface roads, parking lots and airports. It consists of mineral aggregate bound together with asphalt, laid in layers, and compacted.

“Hot-mix”, “hot-mix asphalt”, “hot-mix asphalt concrete” and like terms mean a paving product that is produced by heating asphalt binder to decrease its viscosity, and typically, but not always, drying the aggregate to remove moisture from it prior to mixing with the binder. Mixing is generally performed with the aggregate at about 300° F. (149° C.) for virgin asphalt and about 330° F. (166° C.) for polymer modified asphalt, and the asphalt cement at 200° F. (93° C.). Paving and compaction must be performed while the asphalt is sufficiently hot. Hot-mix asphalt is the form of asphalt concrete most commonly used on high traffic pavements such as those on major highways, racetracks and airfields.

“Recycled asphalt product”, “RAP”, and like terms mean old asphalt that is ground into gravel, and that hardens/binds together when compacted.

“Rejuvenated recycled asphalt”, “rejuvenated RAP” and like terms mean RAP to which asphalt binder has been added. Rejuvenation of RAP is the replacement of some or all of the oils that are lost from the asphalt concrete during asphalt aging. This aging, i.e., asphalt oxidation, is the process in which the effects of the sun's rays, water and air remove or degrade the light oil components of the asphalt which, in turn, promotes cracks and holes in the pavement.

### Packaged, Rubber-Modified Hot-Mix Asphalt Pre-Mix

Asphalt Binder

The asphalt binder, also known as asphalt cement, used in the practice of this invention can comprise any grade of asphalt. The asphalt acts as a binder and binds with the rubber particulates and aggregate. The asphalt is typically a paving grade asphalt so that the rubber-modified, asphalt binder can be directly used as a source for preparing asphalt paving compositions that also include aggregate. The asphalt binder can optionally include other binding components.

The asphalt binder can be a refined residue from distillation of select crude oils. As such, examples of such asphalt binders are commonly abbreviated with the terms AC-xx. The notation “xx” in the description of AC asphalt represents a numeral related to the asphalt viscosity. Asphalts such as AC-20 and AC-10 are the preferred forms to be used as binders. Other forms of asphalt that are contemplated as constituents in binder formulations include AC-1.75, AC-2.5, AC-5, AC-30, AC-40, AC-80, and AC-120 asphalts. Also, the super pave grading system “PG-xx-xx” (e.g., PG-76-22) can be used to identify asphalt binders, wherein the “xx” notations designate temperatures in Celsius for the performance grade, e.g., asphalt binder PG-76-22 is designed for use at temperatures between 76° C. and 22° C.

Rubber

Any rubber, including both natural and synthetic rubbers, that can be blended with the asphalt binder to form a uniform mixture of rubber-modified asphalt can be used in the practice of this invention. In one typical and preferred embodiment, the rubber is obtained from tire rubber in the form of crumb rubber or ground tire rubber. Such tire rubber can be ground into particles and emulsified with the asphalt binder. Additionally, the tire rubber can be pre-reacted into a sticky composition, such as with an asphalt-based composition. Similarly latex rubber can also be used in both its natural and synthetic forms.

The U.S. Standard mesh size of the rubber particles in the rubber-modified asphalt binder is less than the U.S. Standard mesh size of the aggregate particles in the pre-mix, and is typically less than 8 U.S. Standard mesh, more preferably less than U.S. Standard 14 mesh, and most preferably less than 20 U.S. Standard mesh. Crumb rubber comprising ground tires is a preferred form of rubber.

Non-Bituminous Adhesion Promoter

In one embodiment the rubber-modified, asphalt binder comprises one or more non-bituminous adhesion promoters (also known as binders or anti-stripping agents). Any non-bituminous compound or mixture of compounds that will promote the adhesion between the asphalt, rubber and/or aggregate can be used as the non-bituminous adhesion promoter.

In one embodiment, the non-bituminous adhesion promoter can be a hydrophobic polymer that is not bitumen or asphalt based. As such, the hydrophobic binder can be polymer comprised of acrylic acids, methacrylic acids and copolymers, methyl methacrylate copolymers, ethoxyethyl methacrylates, cynaoethyl methacrylate, aminoalkyl methacrylate copolymer, poly(acrylic acid), poly(methacrylic acid), methacrylic acid alkylamide copolymer, poly(methyl methacrylate), poly(methacrylic acid) (anhydride), methyl methacrylate, polymethacrylate, poly(methyl methacrylate), poly(methyl methacrylate) copolymer, polyacrylamide, aminoalkyl methacrylate copolymer, poly(methacrylic acid anhydride), glycidyl methacrylate copolymers, polyolefins, silicones, polypropylenes, polyethylenes, acrylic polymers, polystyrenes, polyethylene-vinyl acetate, polyethylene vinyl alcohol, polyethylene acetate, polyvinylpyrrolidones, chlorinated polyethylenes, polyisoprenes, polybutadienes, styrene-butadiene di- and tri-block polymers, polychloroprenes, polyethylene-propylenes, chlorosulfonated polyethylenes, polyurethanes, styrene isoprene polymers, styrene ethylbutylene polymers, styrene butadiene rubber latex, other rubbers, polychloroprene latex, polymethylmethacrylate, polyethylmethacrylate, polydimethylsiloxanes, and the like. In one embodiment the non-bituminous adhesion promoter is a hydrophobic cellulosic material such as ethylcellulose, or a hydrophilic binder, or a biodegradable polymer such as a polylactic acid, or a natural polymer such as a polysaccharide, or lignin and/or lignosulfonate, or the like. Other examples of non-bituminous adhesion promoters are described in US Patent Application Publication 2010/0056669.

One preferred family of adhesion promoters is the PAVEGRIP glycol amine mixtures available from Pre Tech Industries, Inc.

Additives

The rubber-modified asphalt pre-mix of this invention can optionally include one or more additives. Such additives include, but are not limited to, structural materials (in addition to the aggregate) such as sand, silica, fly ash, ceramic particles, glass particles, and clay particles; pozzolanic materials; pigments such as carbon black; salts; lubricants; plasticizers; and the like. These additives, if present, can be included in the rubber-modified asphalt binder, or admixed with the aggregate, or both. They are used in customary amounts and ways.

Aggregate

Examples of aggregates that can be used in the practice of this invention include, but are not limited to, sand, gravel, crushed stone, slag, recycled concrete, recycled asphalt pavement (RAP), mineral filler, and the like. Aggregates are a component of the asphalt pavement; the aggregate serves as reinforcement to add strength to the overall asphalt pavement or other asphalt material. The average particle size of the aggregate can be fine, medium, and/or coarse, and is typically between ⅝ inch and 325 U.S. Standard mesh, more typically between ½ inch and 270 U.S. Standard mesh, and even more typically between 7/16 inch and 230 U.S. Standard mesh. In one embodiment, the average particle size of the aggregate is greater than the average particle size of the rubber in the rubber-modified asphalt binder. While the smallest aggregate particles can be of the same size as the smallest rubber particles, typically the largest rubber particles do not exceed 30 U.S. Standard mesh while the largest aggregate particles can be as large as ⅝ inch.

Rubber-Modified Asphalt Binder

The relative amounts of asphalt binder, aggregate, non-bituminous adhesion promoter and additives in the rubber-modified asphalt binder, in weight percent based on the weight of the rubber modified asphalt binder, are reported in Table 1.

TABLE 1
Rubber-Modified Asphalt Binder Components

| | Broad | Preferred | Most Preferred |
|---|---|---|---|
| Component | (wt %) | (wt %) | (wt %) |
| Asphalt Binder | 71-87 | 74-83 | 77-80 |
| Rubber | 12-27 | 16-25 | 19-22 |
| Non-Bituminous | 0-0.125 | >0-0.1 | 0.5-0.75 |
| Adhesion Promoter | | | |
| Additives | 0-1.5 | >0-1.25 | 0.5-1 |

In one embodiment, the rubber-modified asphalt binder comprises or consists of asphalt binder and rubber. In one embodiment the rubber-modified asphalt binder comprises or consists of asphalt binder, rubber and non-bituminous adhesion promoter. In one embodiment the rubber-modified asphalt binder comprises or consists of asphalt binder, rubber, non-bituminous adhesion promoter, and an additive.

Rubber-Modified Hot-Mix Asphalt Pre-Mix

The relative amounts of rubber-modified asphalt binder and aggregate in the rubber-modified asphalt pre-mix, in weight percent based on the weight of the rubber modified asphalt pre-mix, are reported in Table 2.

TABLE 2
Rubber-Modified, Hot-Mix
Asphalt Pre-Mix Components

| | Broad | Preferred | Most Preferred |
|---|---|---|---|
| Component | (wt %) | (wt %) | (wt %) |
| Rubber-Modified | 1-20 | 3.5-15 | 4.7-8.85 |
| Asphalt Binder | | | |
| Aggregate | 80-98 | 85-96 | 91-95 |
| Polyolefin | 0-1 | >0-0.5 | 0.05-0.3 |

In one embodiment, the rubber-modified, hot-mix asphalt pre-mix comprises or consists of rubber-modified asphalt binder and aggregate. In one embodiment, the rubber-modified, hot-mix asphalt pre-mix comprises or consists of rubber-modified asphalt binder, aggregate and polyolefin. In one embodiment the polyolefin is polyethylene. In one embodiment the polyolefin is the melted remains of the polyolefin package in which the pre-mix of rubber-modified asphalt binder and aggregate is packaged, stored and/or shipped.

In one embodiment the rubber-modified, hot-mix asphalt binder component of the rubber-modified asphalt pre-mix comprises or consists of asphalt binder and rubber. In one embodiment the rubber-modified, hot-mix asphalt binder component of the rubber-modified asphalt pre-mix comprises or consists of asphalt binder, rubber and non-bituminous adhesion promoter. In one embodiment the rubber-modified, hot-mix asphalt binder component of the rubber-modified asphalt pre-mix comprises or consists of asphalt binder, rubber, non-bituminous adhesion promoter, and an additive.

### Process for Making a Packaged, Rubber-Modified Asphalt Pre-Mix

Preparation of the Rubber-Modified Asphalt Binder

In one embodiment, asphalt binder, e.g., PG 64-22 commercially available from All States Materials Group, is added to a vessel equipped with heating and agitation means, e.g., an atmospherically vented kettle. The binder is heated to a temperature of 150 to 200° C., more typically to a temperature of 160 to 190° C. The binder is slowly, e.g., from 200 to 300 revolutions per minute (rpm), stirred during this heating phase to promote an even, fast distribution of the heat throughout the binder. Once the binder has reached its target temperature, e.g., 175° C., the rubber, typically and preferably a crumb rubber of less than 30 U.S. Standard mesh such as MICRODYNE MD-400 micronized rubber powder commercially available from Lehigh Technologies, is slowly added to the stirred binder to promote an even distribution of the rubber throughout the binder. Once the rubber has been completely added, e.g., to about 20 weight percent (wt %) of the combined weight of the asphalt binder and rubber, a non-bituminous adhesion promoter, e.g., PAVEGRIP PA-300 commercially available from Pre Tech Industries, is added to the asphalt binder/rubber mix, e.g., to about 1 wt % of the combined weight of the asphalt hinder, rubber and non-bituminous adhesion promoter. Additives, e.g., pigment, filler, etc., are usually added at this time as well. Once the non-bituminous adhesion promoter and any additives are added, the kettle is typically closed and mixed at a greater rate, e.g., from 600 to 800 rpm, while maintaining the mix at its target temperature, i.e., the temperature at which the rubber and non-bituminous adhesion promoter are added to the asphalt binder. The additional mixing continues until the contents of the kettle are blended into a substantially homogeneous mass, typically for 30 minutes to 2 hours, more typically for 45 minutes to 1.5 hours.

In one embodiment the asphalt binder, e.g., PG 64-22, is stirred until it reaches the desired temperature, e.g., 150 to 200° C., more typically to a temperature of 160 to 190° C., and then the stirring speed is increased while the crumb rubber is slowly added. Once the crumb rubber is completely added to the binder, the non-bituminous adhesion promoter is added without reducing the stirring speed. Stirring at this speed continues until the all three ingredients form a substantially homogeneous mass at which time the stirring speed is reduced and continued until the mass is ready for packaging. The initial, increased and reduced stirring speeds are similar to the slow and fast speeds described for the previous embodiment.

Preparation of the Packaged, Rubber-Modified Asphalt Pre-Mix

In an operation independent of the preparing the rubber-modified asphalt binder, aggregate is packaged, e.g., added to a polyolefin, typically a polyethylene, bag. In one embodiment the package is a bag comprising low density polyethylene (LDPE). The dimensions of the package can vary. In one embodiment, the package is a 3-mil thick, 16 inch by 18 inch LDPE bag designed to hold about 25 pounds of hot-mix pre-mix, i.e., a mix comprising aggregate and rubber-modified, asphalt binder.

Once the aggregate is packaged, the package is ready to receive the rubber-modified asphalt binder and, optionally, the non-bituminous adhesion promoter and any additives. As noted above, preferably the non-bituminous adhesion promoter and any additives are added directly to the asphalt binder, either before or after the addition of the rubber but preferably after the addition of the rubber. In one embodiment, a preferred embodiment, after the asphalt binder has been agitated (e.g., stirred) until it is a substantially homogeneous mass, it is allowed to cool, typically by transferring it to a storage vessel. The substantially homogeneous mass of rubber-modified asphalt binder is allowed to cool to a temperature at which it is still pumpable but will not adversely affect the package holding the aggregate. In an embodiment in which the package is an LDPE bag, the temperature to which the rubber-modified asphalt binder is cooled is from 90 to 125° C., more typically from 100 to 120° C.

The rubber-modified asphalt binder is added to the aggregate in the bag in a manner such that minimizes the contact between the binder and the interior of the package. Typically, this is accomplished by adding the binder to the center of the aggregate. In one embodiment, the rubber-modified asphalt binder is added in one step. In a preferred embodiment, the rubber-modified asphalt binder is added in multiple steps. After the rubber-modified asphalt binder is completely added to the aggregate, the package is sealed, typically heat sealed. In one embodiment the package is an LDPE bag and the bag is heat sealed. In a preferred embodiment, the rubber-modified asphalt binder is first added to a container, typically and preferably a cylindrical container, which holds the aggregate, the aggregate and rubber-modified asphalt binder are mixed, either actively (e.g., tumbled) or passively (e.g., the flow of binder through the aggregate due to gravity), and then the mix is transferred into a polyolefin bag, e.g., LDPE, and the bag is heat sealed.

In one embodiment sufficient rubber-modified asphalt binder is added to the aggregate such that the resulting pre-mix comprises from 3 to 15 wt % rubber-modified asphalt binder and from 85 to 97 wt % aggregate. In one embodiment sufficient rubber-modified asphalt binder is added to the aggregate such that the resulting pre-mix comprises from 5 to 10 wt % rubber-modified asphalt binder and from 90 to 95 wt % aggregate.

### Use of the Packaged, Rubber-Modified, Hot-Mix Asphalt Pre-Mix

The packaged, rubber-modified, hot-mix asphalt pre-mix of this invention is particularly useful in the patching of asphalt and concrete pavement, particularly potholes. In one embodiment, the packaged pre-mix is transported to the site of the asphalt or concrete pavement repair at which it is loaded into a pug mill or similar equipment. The package in which the rubber-modified, hot-mix asphalt pre-mix is contained is as described above, e.g., bags made of polyethylene and sized to contained about 25 pounds of pre-mix. The pug mill can vary in size but typically has a rated capacity of about 400 pounds of pre-mix. If the pug mill is of the design as described below, then the bags of pre-mix can be loaded into the pug mill without opening, i.e., in the sealed state in which the pre-mix was stored and shipped. If the pug mill is not designed to open the bags of pre-mix, then the bags are first opened in any convenient manner, preferably at least a portion, if not all, of the pre-mix contents poured into the mill, and the bag itself loaded into the mill. The mill is operated at conditions, e.g., temperature, agitation and residence time, such that the bag is melted and the contents of the mill, e.g., pre-mix, polyolefin (melted bag) and any additives, are blended into a substantially homogeneously mass. Typical operating conditions of the mill include a temperature of 160° C. to 190° C., and mixing devices, e.g., paddles, scrapers, etc., rotating at 8 to 15 revolutions per minute (rpm), for 8 to 25 minutes. Typically the pug mill is pre-heated to the desired temperature range and the mixing devices are rotating at the desired rpm at the time the bags are loaded into the mill. Once the mill contents are substantially homogeneously mixed and are at the desired temperature, the contents are discharged from the mill either directly into the repair site, e.g., pothole, or into a conveyance devices, e.g., wheelbarrow, for transport to the repair site. The contents at this stage are typically in the form of a thick, semi-solid mass that can be worked to conform to the hole or crack in need of repair. The semi-solid mass is densified using a suitable compaction or densification tool to reduce the voids entrapped and establish contact between the larger aggregates. This densification makes the mix resistant to movements under heavy loading and also relatively impermeable to water and other fluids.

### Packaged, Rubber-Modified, Molded Asphalt Sans Aggregate

In one embodiment the invention is a packaged, rubber-modified, molded asphalt mixture, sans (i.e., without) aggregate, in a polyolefin bag or other polyolefin package. This packaged material is not pelleted and in one embodiment, a preferred embodiment, it is not coated with either lime or other coating material. However, the asphalt mixture is molded prior to packaging. Other than for the molding and absence of aggregate, this packaged material is compositionally alike in all respects to the packaged, rubber-modified asphalt pre-mix described above.

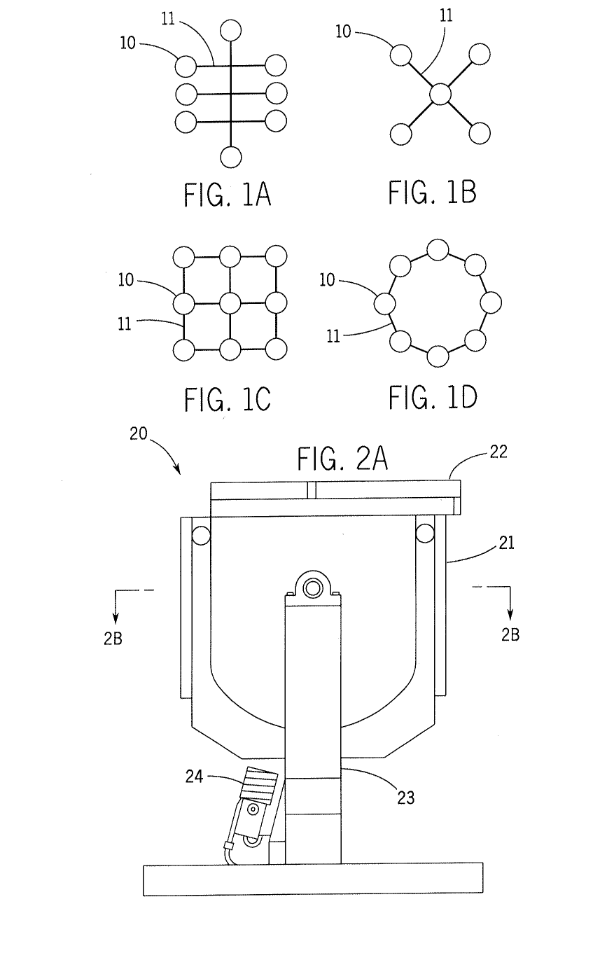

Once the asphalt binder, rubber and non-bituminous adhesion promoter are uniformly blended into a substantially homogeneous composition, the composition, while still hot and fluid, is transferred from the mixer to a mold in which it is allowed to solidify at least to a point where it can be removed from the mold and packaged without substantial loss of its molded shape. The shape and size of the molded product can vary to convenience but in one embodiment, a preferred embodiment, the product is molded such that it comprises discreet nodes joined to one another by runners. The nodes and runners can be of any size and shape, but typically the nodes are of a much greater mass and/or thickness than the runners that join them. In one embodiment, the nodes have a polygonal (e.g., cubic) or curved (e.g., spherical) shape while the runners have a generally linear, rod-like configuration, and the mass or weight of the average node is at least 10%, or 20%, or 30%, or 40%, or 50%, or 60% or 70%, or 80%, or 90% greater than that of the average runner. While the shape of the molded composition itself, as opposed to its component parts of nodes and runners, can also vary widely, typically the molded composition has a generally flat configuration to facilitate packaging. FIGS. 1A-1D illustrate various configurations of the molded composition. FIG. 1A illustrates a branched configuration, FIG. 1B illustrates a hub and spoke configuration, FIG. 1C illustrates a grid configuration, and FIG. 1D illustrates a ring configuration. Numerous other configurations are, of course, possible (e.g., star, string and bead, etc.) as are variations on these illustrated configurations (e.g., the addition of more nodes and/or runners while retaining the general shape of the configuration) but in all such configurations, the generally more massive nodes 10 are connected to one another by the generally less massive runners 11.

In one embodiment, the molded asphaltic composition weights from 1 to 4 pounds, preferably from 1.5 to 3 pounds, before packaging. In one embodiment, the nodes are from 0.5 to 3 inches, preferably from 1 to 2 inches in diameter or cross-section, and are connected by runners from 0.1 to 1 inch, preferably from 0.2 to 0.5 inch, in length. In one embodiment, a nonpreferred embodiment, the molded composition can be dusted with an anti-sticking agent, e.g., lime or sulfur, before it is packaged or after it is packaged but before the package is sealed so as to avoid or diminish sticking of the molded composition to inside of the bag. However, sticking of the molded composition to the inside of the bag can be beneficial to the molded product holding its shape during storage and shipment, particularly under warm or hot conditions. The package for holding the molded composition is made from a polyolefin, typically and preferably low density polyethylene.

The packaged, molded composition is used in the same manner as the packaged, rubber-modified asphalt pre-mix except that the aggregate is typically first mixed with the packaged, rubber-modified, molded asphalt mixture in a pug mill at the asphalt pavement repair site. While this product can be used with any kind of aggregate, it is particularly useful with recycled asphalt product (RAP). The packaged, molded asphaltic composition rejuvenates and rubberizes the recycled asphalt product without the need for first pelletizing and then coating the asphalt binder before packaging. Under the heat and action of the mixer, the difference in size and/or mass between the nodes and runners results in the runners melting first and this, in turn, allows for the nodes to disconnect from one another and melt and dispersed within the aggregate, e.g., RAP, more efficiently and completely. The amount of packaged, molded asphaltic composition used relative to the aggregate is a function of many variables, e.g., the quality of the aggregate, the make-up of the asphaltic composition, the nature of the repair site, etc., and its determination is well within the capabilities of those skilled in the art of pavement repair.

### Mixer (Pug Mill)

In one embodiment the invention uses a mixer, e.g., a modified pug mill, for preparing a hot asphalt mix for asphalt and concrete pavement repair. Such mixers are known in the art, and typically comprise:
(A) A housing having interior and exterior surfaces;
(B) Mixing elements or devices rotationally mounted within the housing;
(C) Scrapers rotationally mounted within the housing, the scrapers positioned within the housing in contact or near contact with at least part of the interior surface of the housing; and
(D) Means for rotating the mixing elements and scrapers within the housing.
   These mixers are typically mobile, e.g., transported to the pavement repair site by truck or wheeled so that it can be towed to the site, and are associated with various equipment to assist in its loading and unloading, e.g., chutes, venting, etc. In one embodiment of this invention the mixers are equipped with mixing elements, e.g., paddles, having jagged exterior edges so as to engage and tear open and shred the polyolefin bags that hold the pre-mix and that are loaded into to mixer. In contrast, the exterior edges of the scrapers are smooth and designed to keep the hot pre-mix from accumulating on the interior surface of the mixer housing.

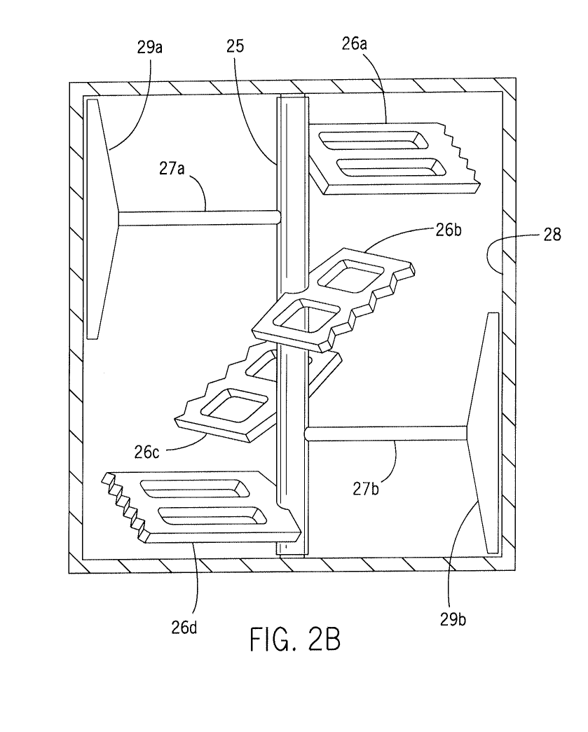

FIG. 2A illustrates one embodiment of a mixer used in this invention. Mixer 20 comprises a housing 21, typically and preferably of a cylindrical design, equipped with an optional lid 22, a supporting base 23, and a burner 24. Housing 21 is open on one end and closed on the opposite end. The closed end of housing 21 is typically of a convex dome configuration.

Supporting base 23 can be of any design and in one embodiment, housing 21 is mounted on supporting base 23 so as to allow the housing to pivot in a manner that allows the contents of the mixer to discharge through the open end of the housing. During mixing operations, the open end of housing 21 can be closed with optional lid 22 which can be attached to housing 21 by any conventional means, e.g., hinges, or it can simply be designed for complete removal during the loading and unloading of the mixer.

Burner 24 is typically not attached directly to the housing, but rather located separate and apart from it and in a manner that allows for the direct heating of the housing which, in turn, heats the asphaltic mix contained within the housing. Typically, burner 24 is located beneath the bottom of housing 21 and spaced apart from it to allow the pivoting of housing 21 without the need for moving burner 24.

FIG. 2B illustrates one embodiment of the interior of housing 21 which is equipped with axle 25 that is positioned along the long or longitudinal axis of the housing and is attached to a motor (not shown) that imparts rotational movement to the axle. The axle is equipped with paddles 26a, 26b and 26c and scrapers 27a and 27b. Both the paddles and scrapers extend radially from the axle, the scrapers in contact or near contact with the interior surface of housing sidewall 28. The number and location of the paddles and scrapers on the axle can vary but in one embodiment, the axle contains at least two scrapers and at least two paddles. The scrapers are designed and positioned on the axle so that the scraper blades provide complete or near complete coverage of the housing sidewalls as the scrapers revolve within the housing. In one embodiment, the mixer is equipped with two scrapers positioned one above the other but extending from the axle opposite to one another, and the action of the lower section of top scraper blade (not shown) overlapping with the action of the top section of lower scraper blade 29b on or near the housing sidewall. The scraper blades have smooth (non-jagged) exterior surfaces, and are designed to maintain the sidewall of the housing clean or relatively clean of the mixer contents.

The paddles are designed and positioned on the axle so as to promote complete mixing of the hot asphalt pre-mix, e.g., asphalt, aggregate, non-bituminous adhesion promoter, polyolefin bag and all additives. Typically the paddles do not extend to the housing sidewalls, and are set an angle other than perpendicular to the housing sidewall.

The exterior edges of the mixer elements, e.g., paddles, of this invention are jagged (non-smooth). The design of the jagged edges can vary, but are such that they can engage, tear open and shred the filled polyolefin bags that are loaded into the mixer. This action not only exposes the contents of the bags to the mixing action of the mixer, but it renders the bag to shred sizes that promote speedy and complete melting of the bag. The polyolefin then serves as a lubricant for the rubberized asphalt pre-mix. For a 3-mil thick bag of 16 inch by 18 inch dimensions, the amount of polyolefin, e.g., LDPE, added to the asphalt pre-mix is about 0.2 weight percent based on the total weight of the pre-mix. This not only promotes the processing of the pre-mix, but it also eliminates the need for discarding and/or recycling the bags.

### EXAMPLE

PG 64-22 asphalt cement binder (13.25 liters) available from All States Materials Group is placed in an atmospherically vented kettle and brought to 175° C. The binder is slowly stirred (approximately 275 rpm) throughout the heating phase to promote quick and even heating. Once the binder has reached 175° C., the speed of the agitator is increased to 700 rpm and<30 U.S. Standard mesh crumb rubber available from Mahantango Enterprises Inc. is slowly added over approximately 15 minutes until it constitutes 21 weight percent (wt %) of the binder/rubber composition. After the crumb rubber is completely added to the binder, non-bituminous adhesion promoter PAVEGRIP 300 is added until it constitutes 0.75 wt % of the total mixture. Upon completion of the addition of the adhesion promoter, the kettle is closed and the contents are allowed to mix at approximately 700 rpm for 60 minutes while maintaining the temperature at 175° C. After the elapse of 60 minutes, the contents of the kettle are pumped to a storage kettle where the temperature of the mixture is cooled to approximately 115° C.

In a separate operation, 10.6 kilograms(Kg) of aggregate are added to a cylindrical container which is open at the top and temporarily closed at the bottom. Subsequently, 0.8 Kg of the mixture in the storage kettle is added to the aggregate in the cylindrical container. The mixture is added at a temperature of 115° C., and it can be added at one time (“one-shot”) or in stages (“multiple shot”). The mixture is added at the top (or bottom) and center or near center of the aggregate in the cylinder so that it diffuses outwardly toward the inner surface of the cylinder. When the appropriate amount of mixture, about 7 wt % of the cylinders contents, is added to the cylinder containing the aggregate, the bottom of the cylinder is opened and the contents of the cylinder are discharged into the bag and ready for sealing and storage and/or shipping. The bag is heat sealed.

Alternatively, in a separate operation, 10.6 kilograms (Kg) of aggregate are added to an open 3-mil thick, 16 inch by 18 inch flexible bag made of LLDPE. Subsequently, 0.8 Kg of the mixture in the storage kettle is added to the aggregate in the bag. The mixture is added at a temperature of 115° C., and it can be added at one time (“one-shot”) or in stages (“multiple shot”). The mixture is added at the top (or bottom) and center or near center of the aggregate in the bag so that it diffuses outwardly toward the inner surface of the bag. When the bag is filled and ready for sealing and storage and/or shipping, the mixture constitutes about 7 wt % of the bag contents. The bag is heat sealed

At the asphalt or concrete pavement repair site, the sealed bag is loaded into a pug mil heated to 170° C. and equipped with mixing elements that have jagged external edges, the bag is shredded and melted, the rubber-modified, hot-mix asphalt pre-mix with adhesion promoter is mixed until it forms a relatively homogeneous mass, and then it is discharged from the mill for deposit into the hole or crack that needs repair.

What is claimed is:

1. A packaged composition comprising:
(A) Rubber-modified asphalt binder;
(B) Non-bituminous adhesion promoter; and
(C) Aggregate;
the composition contained within a polyolefin package.

2. A process for making a packaged, rubber-modified asphalt pre-mix, the process comprising the steps of:
(1) Mixing rubber and asphalt binder at an elevated temperature to form a rubber-modified, liquid asphalt binder; and
(2) Adding the rubber-modified, liquid asphalt binder to a polyolefin package containing aggregate.

3. A method of preparing a molten patching material for repair of asphalt and concrete pavements, the method comprising the steps of:
(1) Subjecting a rubber-modified, asphalt pre-mix contained within a polyolefin package, the pre-mix comprising:
(A) Rubber-modified asphalt binder; and
(B) Aggregate;
to sufficient mixing to open the package; and
(2) Subjecting the open package of rubber-modified asphalt pre-mix to sufficient mixing and heat to melt the package and form a substantially uniform blend of rubber-modified molten asphalt binder, aggregate and melted package.

4. A method of patching asphalt or concrete pavements, the method comprising the steps of:
(1) Preparing a molten, rubber-modified, hot asphalt concrete from a rubber-modified, hot-mix asphalt pre-mix comprising an asphalt binder, aggregate and an adhesion promoter all contained within a polyolefin package; and
(2) Depositing the molten, rubber-modified, hot asphalt concrete onto or into an area of the asphalt or concrete pavement in need of repair.

5. A packaged composition comprising:
(A) Molded, rubber-modified asphalt binder; and
(B) Non-bituminous adhesion promoter;
the composition contained within a polyolefin package.

6. A process for making a packaged, rubber-modified asphalt binder to rejuvenate and rubberize recycled asphalt product (RAP), the process comprising the steps of:
(1) Mixing rubber, asphalt binder and a non-bituminous adhesion promoter at an elevated temperature to form a rubber-modified, liquid asphalt binder;
(2) Molding the rubber-modified, asphalt binder; and
(3) Adding the molded, rubber-modified, liquid asphalt binder to a polyolefin package.

7. A process of rejuvenating recycle asphalt product (RAP), the process comprising the steps of:
(1) Heating RAP,
(2) Adding to the RAP a packaged, molded composition comprising:
(A) Asphalt binder;
(B) Rubber;
(C) A non-bituminous adhesion promoter; and
(D) A polyolefin package;
the composition contained within the polyolefin package; and
(3) Mixing the heated RAP and packaged, molded composition until both the package and molded composition are liquefied and form a substantially homogeneous blend with the RAP.

8. The process of claim 2 in which the rubber is a crumb rubber.

9. The composition of claim 1 in which the rubber is a crumb rubber.

10. The method of claim 3 in which the rubber in the rubber-modified asphalt binder is crumb rubber.

11. The process of claim 2 further comprising the step of adding a non-bituminous adhesion promoter to the rubber and asphalt binder to form the rubber-modified, liquid asphalt binder.

12. The process of claim 6 in which the rubber is a crumb rubber.

13. The process of claim 7 in which the rubber is a crumb rubber.

14. The composition of claim 5 in which the rubber is a crumb rubber.

15. The method of claim 4 in which the rubber in the rubber-modified asphalt binder is crumb rubber.
